(19) United States
(12) Patent Application Publication
(10) Pub. No.: US 2024/0106052 A1
(43) Pub. Date: Mar. 28, 2024

(54) ADAPTER AND ELECTRIC APPARATUS

(71) Applicant: Koki Holdings Co., Ltd., Tokyo (JP)

(72) Inventor: Tomomasa NISHIKAWA, Ibaraki (JP)

(73) Assignee: Koki Holdings Co., Ltd., Tokyo (JP)

(21) Appl. No.: 18/270,192

(22) PCT Filed: Jan. 28, 2022
(86) PCT No.: PCT/JP2022/003218

§ 371 Date: Jun. 28, 2023

(30) Foreign Application Priority Data
Feb. 12, 2021 (JP) 2021-020550

(51) Int. Cl. H01M 50/244; H01M 10/42; H01M 50/247; H01M 50/296

(52) U.S. Cl. CPC H01M 50/244; H01M 10/425; H01M 50/247; H01M 50/296; H01M 2010/4271; H01M 2010/4278

(57) ABSTRACT

Provided is an adapter 200 that is interposed between the battery pack 150 and an electric apparatus body 1, the adapter 200 having a first installation part 210 in which the battery pack 150 can be installed, and a second installation part 250 that can be installed in the electric apparatus body 1. The first installation part 210 has a first communication terminal that can be connected to a communication terminal of the battery pack 150, and the second installation part 250 has a second communication terminal that can be connected to a communication terminal of the electric apparatus body 1. A control unit is provided to the adapter 200. On the basis of an input signal inputted from one of the first and second communication terminals, a signal is outputted by the control unit to the other of the first and second communication terminals.

### TECHNICAL FIELD

The invention relates to an adapter for installing a different type of battery pack to an electric apparatus body and an electric apparatus using the adapter.

### RELATED ART

Among electric tools powered by motors, or electric apparatuses, such as illumination, sound, and heating apparatuses operating using electric power, electric apparatuses which adopt detachable secondary batteries (battery packs) as the power source, namely cordless electric apparatuses, are broadly used. In cordless electric apparatuses, battery packs of different shapes are used by different manufacturing companies. Also, even in the same manufacturing company, in order to diversify battery voltages or increase battery capacities, various battery packs are developed and sold. In order to install such own-company battery packs of different specifications or different models to other own-company electric apparatus bodies, an invention with an adapter interposed between an electric apparatus body and a battery pack has been proposed. Such conventional technique has been disclosed in Patent Document 1, for example. In Patent Document 1, an adapter is interposed between an electric apparatus body and a battery pack, and a installation part structurally directly connectible with an battery pack installation part of the electric apparatus body is formed in the adapter. Since a battery pack installation part of a shape corresponding to the battery pack is formed in the adapter, it is possible to install the battery pack to the adapter.

### PRIOR ART DOCUMENT(S)

### Patent Document(s)

Patent Document 1: Japanese Laid-open No. 2008-178278

### SUMMARY OF INVENTION

### Technical Problem

In the case where the adapter disclosed in Patent Document 1 is adopted, it is possible to connect a battery pack of a different battery pack installation mechanism to the electric apparatus body. However, in the case where a battery pack having a communication terminal able to communicate with the electric apparatus body is used, since the specification of the communication terminal is different, an issue that the communication between the electric apparatus body and the battery pack is not possible may arise. In addition, since the specification or the shape of the battery pack differs from one manufacturing company to another, for example, a battery pack of another manufacturing company (other-company battery pack) cannot be installed to an electric apparatus body made by the company as owned by the user. If an other-company battery pack is installed to the electric apparatus body, even if an adapter is used for connection, the compatibility of the specification among different communication terminals has become an issue.

The invention has been made in view of the above, and an objective of the invention is to provide an adapter allowing communication between an electric apparatus body and a battery pack not directly connectible with the electric apparatus body, such as an other-company battery pack, and an electric apparatus using the adapter. Another objective of the invention is to provide an adapter able to convert a communication signal from a battery pack to a signal which an electric apparatus body is able to process and an electric apparatus using the adapter. Yet another objective of the invention is to provide an adapter able to connect a battery pack not compatible (not directly connectible) with a battery pack connection part of an electric apparatus body to the electric apparatus body and an electric apparatus using the adapter.

### Solution to Problem

The features of the invention disclosed in the application are as follows. According to a feature of the invention, an adapter is provided. The adapter is connected between a battery pack and an electric apparatus body. The adapter includes: a first installation part, which has a first communication terminal connectible with a communication terminal of the battery pack and to which the battery pack is installable; a second installation part, which has a second communication terminal connectible with a communication terminal of the electric apparatus body and is installable to the electric apparatus body; and an adapter control unit, connected with the first communication terminal and the second communication terminal and, configured to, based on an input signal input from one of the first communication terminal and the second communication terminal, output an output signal to an other of the first communication terminal and the second communication terminal. The first installation part and the second installation part have different shapes, and the adapter is configured to be able to install the battery pack corresponding to the first installation part to the electric apparatus body corresponding to the second installation part. In addition, the first installation part and a body side installation part of the electric apparatus body have different shapes, and the battery pack is directly installable to the first installation part and not directly installable to the body side installation part.

According to another feature of the invention, a pair of first rail mechanisms substantially extending in parallel are formed at the first installation part, and a pair of second rail mechanisms substantially extending in parallel are formed at the second installation part, and the first rail mechanisms and the second rail mechanisms respectively have different shapes. The adapter is formed in a split form with a first housing and a second housing. A side of the first rail mechanisms is provided at a side of the first housing, and an other side is provided at the second housing. In addition, a side of the second rail mechanisms is provided at the side of the first housing, and an other side is provided at the second housing, and the first and second housings are split in a direction intersecting with extension directions of the first rail mechanisms and the second rail mechanisms. Moreover, the adapter control unit is configured to, in accordance with the input signal input from one of the battery pack and the electric apparatus body, output the output signal different from the input signal or the output signal corresponding to the input signal to an other of the battery pack and the electric apparatus body.

According to yet another feature of the invention, the adapter includes: a battery side power terminal, connected with a power terminal of the battery pack that is connected; and an apparatus side power terminal, connected with a power terminal of the electric apparatus body. The battery side power terminal and the apparatus side power terminal are directly connected or connected without via the adapter control unit. In addition, the adapter control unit is provided at a substrate, and the first and second communication terminals are connected with the adapter control unit via the substrate, and the battery side power terminal and the apparatus side power terminal are connected with each other without via the substrate. Moreover, the adapter control unit is formed by using a logic computation circuit or a computation circuit using a microcomputer, and the adapter is provided with a power circuit supplying an operation voltage to the computation circuit from power supplied from the battery side power terminal.

According to yet another feature of the invention, an electric apparatus is formed by using the adapter and a battery pack, and the electric apparatus includes an electric apparatus body having a battery pack installation part connectible with the adapter and a load part.

### Effects of Invention

According to the invention, by using the adapter which converts the communication signal transmitted from the battery pack to the electric apparatus body or from the electric apparatus body to the battery pack, the battery pack of the own company or another company having a different configuration of the battery pack installation part is usable. In addition, the communication between the battery pack and the electric apparatus body is possible. In addition, since the control unit is provided in the adapter, the communication signal output from the battery pack can be converted into the communication signal that the electric apparatus body can process to be transmitted to the electric apparatus body. As a result, even in the case where a different batter pack not compatible (not directly connectible) with the electric apparatus body is used, it is possible to exert optimized discharge control based on the state of the battery pack. In addition, in the case where the electric apparatus body is a charging device, it is possible to exert optimized charge control based on the state of the battery pack.

### BRIEF DESCRIPTION OF DRAWINGS

FIG. 1 is a perspective view illustrating a state in which an electric apparatus body 1 and a battery pack 150 are connected (installed) via a first adapter 200 according to an embodiment of the invention.

FIG. 2 is an expanded perspective view illustrating a state in which the first adapter 200 and the battery pack 150 are removed from the state of FIG. 1.

FIG. 3 is an expanded perspective view illustrating the state of FIG. 2 from different angle.

FIG. 4 is an exploded perspective view of the first adapter 200 shown in FIG. 1.

FIG. 5 illustrates longitudinal cross-sectional views of the first adapter 200 shown in FIG. 1, wherein (A) of FIG. 5 is a cross-sectional view of a left-right direction and (B) of FIG. 5 is a cross-sectional view of a front-rear direction.

FIG. 6 is a circuit diagram when an own-company battery pack 100 is installed to the electric apparatus body 1 of FIG. 1.

FIG. 7 is a circuit diagram when an other-company battery pack 150 is installed to the electric apparatus body 1 of FIG. 1 via the first adapter 200.

FIG. 8 is a waveform of an input signal and an output signal of an adapter control unit in the first adapter 200 of FIG. 7.

FIG. 9 is an expanded perspective view when the own-company battery pack 100 is installed to an other-company electric apparatus body 401 by using a second adapter 300.

FIG. 10 is a portion of a circuit diagram when the own-company battery pack 100 is installed to the other-company electric apparatus body 401 of FIG. 9 via the second adapter 300.

FIG. 11 is a waveform of an input signal and an output signal of an adapter control unit in the second adapter 300 of FIG. 10.

FIG. 12 is a waveform illustrating a modified example of FIG. 8.

### DESCRIPTION OF EMBODIMENTS

### Embodiment 1

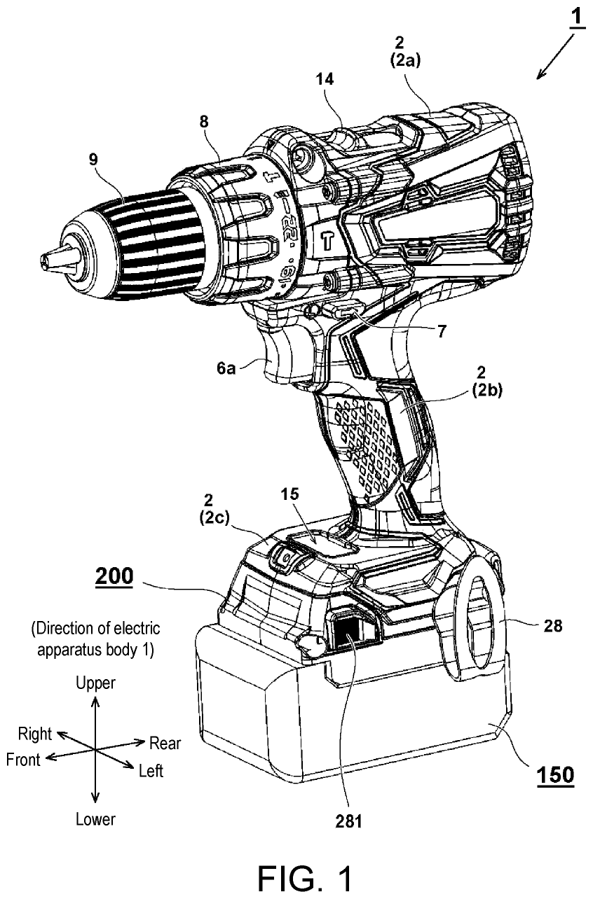

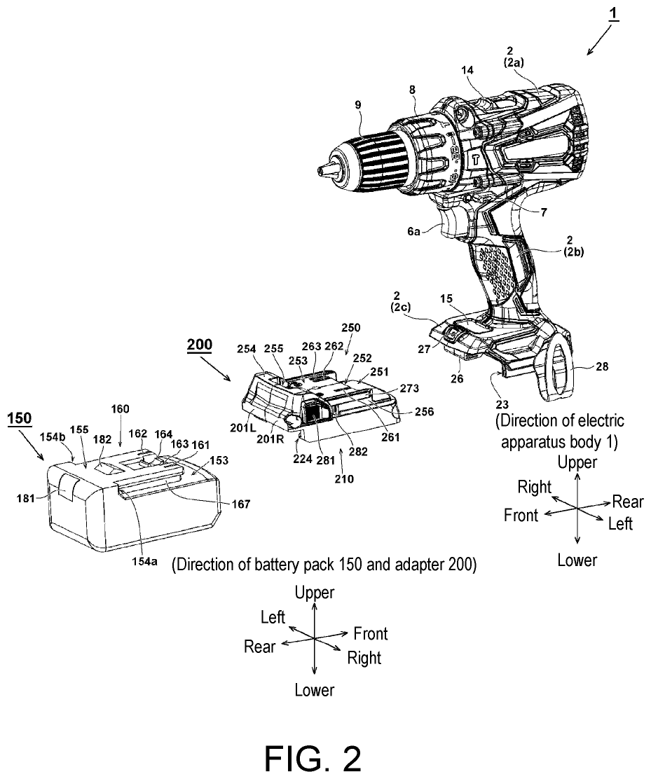

In the following, an embodiment of the invention is described based on the drawings. In the embodiment, as an example of an electric apparatus, an example of an electric tool that drives a motor by using a battery pack as a power source and performs an operation for fastening, for example, a screw is used for description. In the following drawings, like parts are labeled with like symbols, and the repeated descriptions are omitted. In addition, in the specification, the front-rear direction and the left-right direction of the battery packs 100, 150 and the adapters 200, 300 are as shown in FIGS. 2, 4, and 5, and are opposite to the front-rear direction and the left-right direction (see FIGS. 1 and 2) of an electric tool body 1.

FIG. 1 is a perspective view illustrating a state in which the electric apparatus body (electric tool body) 1 and the battery pack 150 are connected (installed) via a first adapter 200 according to an embodiment of the invention. Although the electric tool as a mode of the electric apparatus is an electric tool in which the battery pack 150 is installed to the electric apparatus body 1, the first adapter 200 exhibiting the characteristic of the embodiment is interposed between the electric apparatus body 1 and the battery pack 150. The electric apparatus body 1 is an apparatus rotating or driving a tip tool (not shown) held in a chuck mechanism 9 via a power transmission mechanism (not shown) through rotating a motor 4 with the detachable battery pack 150 as a power source. Although various combinations, such as a deceleration mechanism and a clutch mechanism, a deceleration mechanism and an impact mechanism, etc., in addition to a deceleration mechanism, are considered as the power transmission mechanism not shown herein, FIG. 1 illustrates the appearance of a driver drill having a deceleration mechanism and a clutch mechanism.

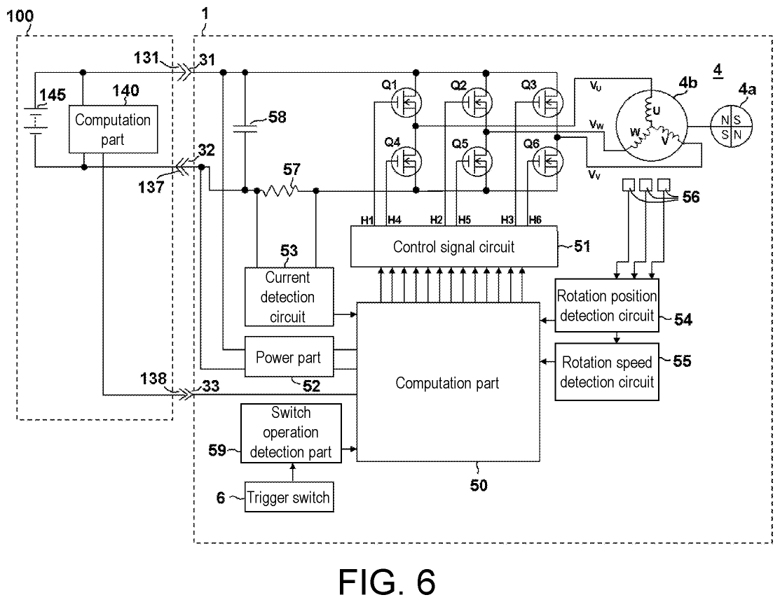

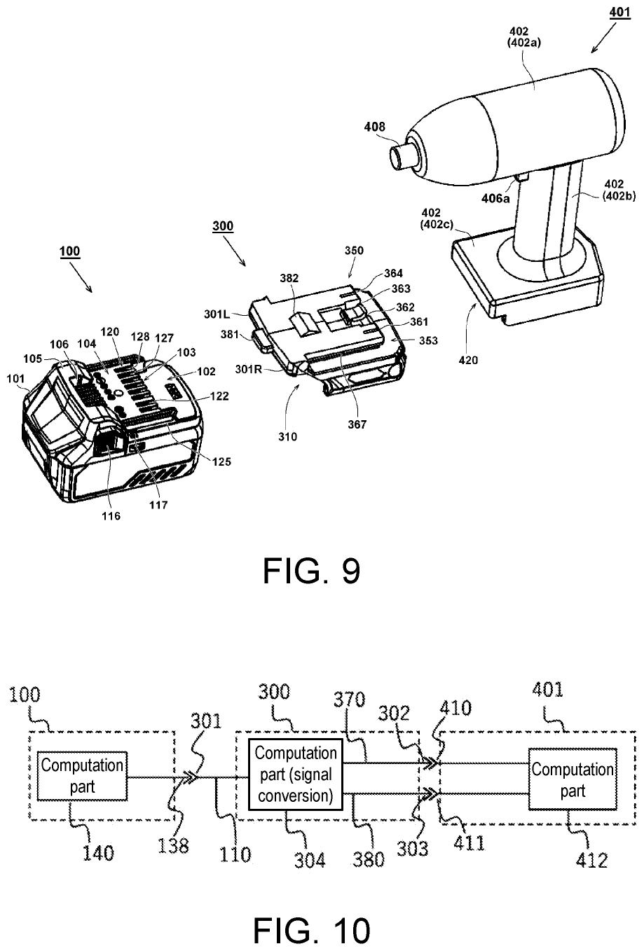

The housing 2 is formed by three main components, which are: a body part 2a having a substantially cylindrical shape and accommodating the power transmission mechanism such as the motor 4 or the clutch mechanism, etc.; a grip part 2b that is a portion extending perpendicularly from the axial direction of the body part 2a and gripped by the operator; and a battery pack installation part (body side installation part) formed at the tip (the side away from the body part 2a) of the grip part 2b. The housing 2 is integrally manufactured by using synthetic resin, such as plastics, so as to be splitable into two in the left-right direction on a vertical surface including the rotation axis of the motor 4. A trigger switch 6 (not shown in the drawing, reference of the symbol is made to FIG. 6 to be described afterwards) is provided above the grip part 2b and immediately below the body part 2a, and a trigger lever 6a for operating the trigger switch 6 is exposed to the front side from the grip part 2b. The battery pack installation part 2c accommodates a control circuit (not shown in the drawing) for controlling the electric apparatus body 1, and is formed for disposing a rail mechanism and a latch mechanism for installing the battery pack 100 (see FIG. 9 to be described in the following). In addition, on the outer upper surface of the battery pack installation part 2c, an operation panel is provided, in which a battery level of the battery pack 100 (see FIG. 9), 150, is displayed, and a lighting switch of an illumination device 27 is provided.

Although a battery pack sold by the manufacturing company of the electric apparatus body 1 (the battery pack 100 to be described in FIG. 9, referred to as “own-company battery pack” in the following) can normally be installed to the battery pack installation part 2c, the first adapter 200 is used in order to install the other-company battery pack 150 in the embodiment. By interposing the first adapter 200 between the electric apparatus body 1 and the other-company battery pack 150, the battery pack 150 sold by a manufacturing company (other company) different from that of the electrical apparatus body 1 can be installed to the electric apparatus body 1.

The battery pack 150 (second battery pack) is a battery pack that cannot be directly installed to the electric apparatus body (a first electric apparatus body that is the electric apparatus body 1), such as a battery pack of a different type of the same manufacturing company as that of the electric apparatus body 1 or a battery pack of another company or a manufacturing company different from that of the electric apparatus body 1, and has a rated voltage corresponding to the operation voltage of the electric apparatus body 1. The battery pack 150 may also be a battery pack with a different rated voltage. The battery pack 150 can be installed to a first installation part 210 (reference of the symbol is made to FIG. 2 to be described in the following) of the lower side of the first adapter 200. On the upper side of the first adapter 200, a second installation part 250 (reference of the symbol is made to FIG. 2 to be described in the following) to be installed to the battery pack installation part 2c of the electric apparatus body 1 is formed. The side surface shape of the first adapter 200 is arranged in a shape continuous with the side surface shape of the battery pack installation part 2c of the electric apparatus body 1. Similarly, the side surface shape of the lower side of the first adapter 200 is arranged in a shape continuous with the left and right side surfaces and the front surface of the battery pack 150.

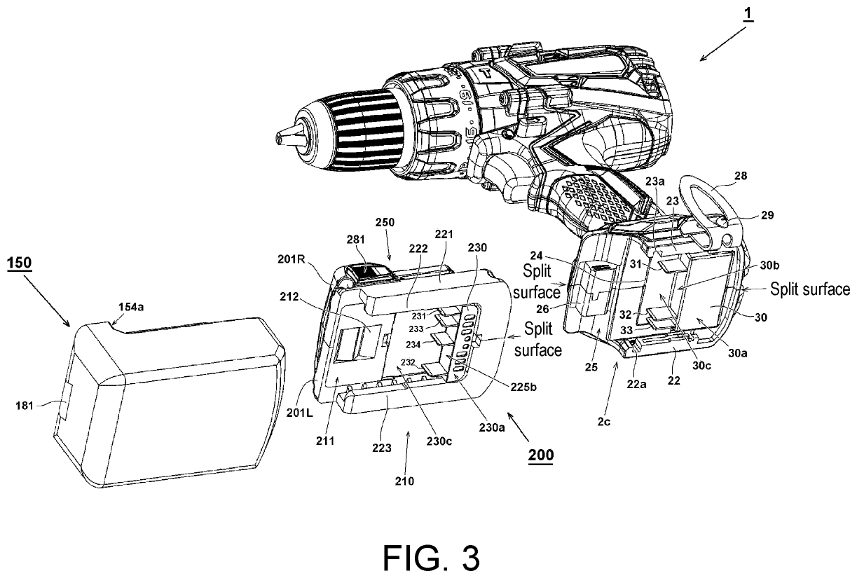

In the battery pack 150, two sets of cell sets in which five lithium ion battery cells are connected in series are provided, and, by connecting the positive electrodes and the negative electrodes of the two sets in parallel, the battery pack 150 outputs a DC 18V (rated). With the battery pack 150 being installed to the battery pack installation part 2c via the first adapter 200, the electric tool shown in FIG. 1 forms a shape elongated downward with respect to the configuration in which the own-company battery pack 100 (see FIG. 9, the first battery pack) that is directly connectible to the electric apparatus body 1 is installed. A hook 28 for hanging the electric tool from a waist belt or the like is attached to the side surface of the battery pack installation part 2c of the electric apparatus body 1 by using a screw 29 (see FIG. 3). Therefore, the hook 28 does not cause interference with the installation and the removal of the first adapter 200.

In the case where the battery pack 150 is used, a mounting body which can be installed to the battery pack installation part 2c of the electric apparatus body 1 is an integrated body of the first adapter 200 and the battery pack 150. The first adapter 200 can be installed by sliding the battery pack 150 rearward from the front with respect to the battery pack installation part 2c. That is, the installation of the first adapter 200 is the same as the procedure of installing the own-company battery pack 100 (see FIG. 9). Regarding the removal of the first adapter 200, the removal is carried out by relatively moving the first adapter 200 toward the front side with respect to the electric apparatus body 1 while pressing latch buttons 281, 283 (not shown in FIG. 1) provided on the side of the first adapter 200.

Regarding the removal of the battery pack 150 from the first adapter 200, the removal is carried out by relatively moving the battery pack 150 toward the front side with respect to the first adapter 200 while pressing a latch button 181 provided on the side of the battery pack 150. Also, either of the removal of the first adapter 200 from the electric apparatus body 1 and the removal of the battery pack 150 from the first adapter 200 may be performed first. When the first adapter 200 is removed from the electric apparatus body 1 from the installation state shown in FIG. 1, the state in which the battery pack 150 is installed to the lower side of the first adapter 200 is maintained.

FIG. 2 is an expanded perspective view illustrating a state in which the first adapter 200 and the battery pack 150 are removed. The first adapter 200 is an interposed component that is interposed when the other-company battery pack 150, for example, is installed to the own-company electric apparatus body 1. A case 201 of the first adapter 200 is split into two, that is, a right side piece 201R and a left side piece 201L, the first installation part 210 for installation of the battery pack 150 is formed on the lower side, and the second installation part 250 for installation to the electric apparatus body 1 is formed on the upper side. The shape of the second installation part 250 is the same as the installation part of the own-company battery pack 100 (reference is made to FIG. 9 to be described afterwards), and is a shape compatible (directly connectible) with the battery pack installation part 2c of the own-company electric apparatus body 1. Accordingly, by using the same procedure as that of the own-company battery pack 100 (reference is made to FIG. 9 to be described afterwards), the first adapter 200 can be installed to the electric apparatus body 1 and can be removed from the electric apparatus body 1.

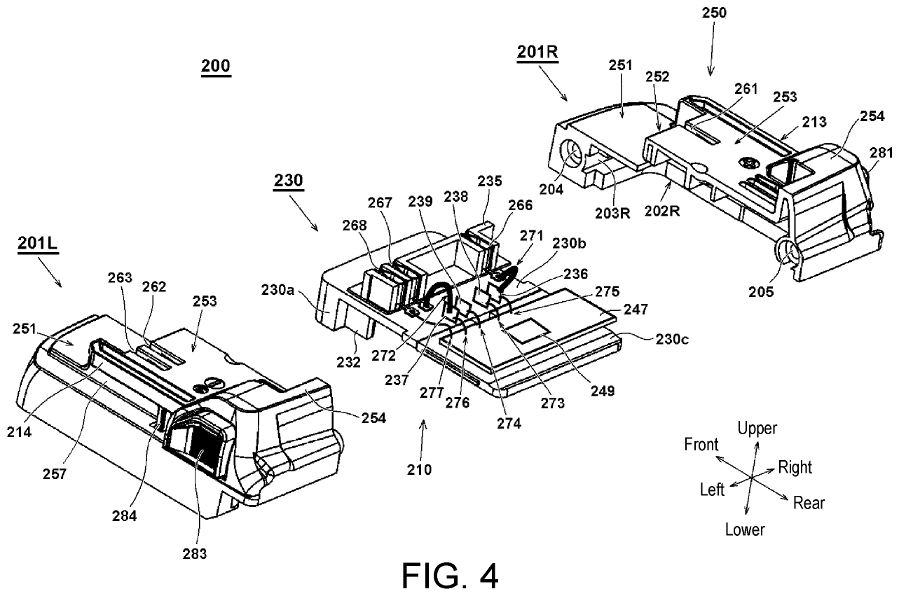

In the second installation part 250 of the first adapter 200, a lower stage surface 251 and an upper stage surface 253 are formed in a stepped shape, and three slots 261 to 263 cut to extend rearward from a stepped part 252 are formed. The inner spaces of the portions opened by the slots 261 to 263 are arranged as spaces accommodating connection terminals to be described afterwards (terminals 266 to 268 of FIG. 4 to be described afterwards). A raised part 254 that is raised is formed behind the upper stage surface 253, and a recess 255 corresponding to a convex part 26 formed in the electric apparatus body 1 is formed at the center of the raised part 254.

On a right side surface 213 of the second installation part 250, a groove part 256 recessed toward the inner side (the direction of the left-right center line) with respect to the right side surface 213 is formed. Although not shown in FIG. 2, a groove part 257 (reference is made to FIG. 4 to be described afterwards) is also formed in a left side surface 214 on the left side of the second installation part 250. The pair of groove parts 256, 257 disposed on the left and right form a rail mechanism. The latch buttons 281, 283 (reference of the symbols are made to FIG. 4 to be described afterwards) are provided behind the groove parts 256, 257. The latch buttons 281, 283 are removal buttons for removing the latch mechanism (lock mechanism) for maintaining or removing the installation of the first adapter 200 to the electric apparatus body 1. The latch mechanism is formed by including the latch buttons 281, 283 and latch claws 282, 284 (see FIG. 4) moving in conjunction with the latch buttons 281, 283.

The first installation part 210 is formed to be not compatible with the battery pack installation part 2c of the electric apparatus body 1 and compatible with an installation part 160 (having the same shape as the installation part 160) of the other-company battery pack 150, for example. The installation part 160 is formed by a rail mechanism formed by a pair of groove parts 167, 168 (not shown in FIG. 2) disposed on the left and right, slots 161 to 164, and a latch mechanism (181, 182). The battery pack 150 has an upper stage surface 155 and a lower stage surface 153, and the slots 161 to 164 cut rearward are formed in the vicinity of the step difference between the upper stage surface 155 and the lower stage surface 153. Connection terminals fit with a connection terminal group (to be described afterwards in FIG. 3) formed at the first installation part 210 of the first adapter 200 are accommodated in the inner sides of the slots 161 to 164. Here, when the raised part 254 formed in the second installation part 250 of the first adapter 200 is inserted to abut against a curved wall 25 of the battery pack installation part 2c of the electric apparatus body 1, the terminals provided on the side of the battery pack installation part 2c and the terminals (to be described in FIG. 3) provided in the first adapter 200 are fit. The latch button 181 formed in the battery pack 150 is pushed to move the latch claw 182 downward (retracts to the inner side). In addition, through removal of the pushing of the latch button 181, due to a spring force, the latch button 181 returns to the original position and the latch claw 182 returns to the original position (the position shown in FIG. 2) in the upper direction. In addition, due to the effect of a spring not shown herein, the claws 282, 284 of the first adapter 200 dash out in a direction perpendicular to the longitudinal direction of the rail part (the groove parts 256, 257), and, by engaging with concave parts 22a, 23a (reference is made to FIG. 3 to be described afterwards) formed in the battery pack installation part 2c, the first adapter 200 is prevented from falling off.

FIG. 3 is an expanded perspective view illustrating the state of FIG. 2 from a different angle. On the lower side of the electric apparatus body 1, the battery pack installation part 2c for installation of the battery pack 100 (see FIG. 9) is formed. The battery pack installation part 2c is mainly formed by rails 22, 23 formed in parallel to extend in the front-rear direction on the left and right side surfaces and connection terminals 31 to 33 disposed between the rails 22, 23. The connection terminals 31 to 33 is formed by the positive electrode terminal 31 and the negative electrode terminal 32 for receiving power and the communication terminal 33 for receiving a signal from the battery pack 150. Here, although one communication terminal 33 for communication is formed, the number of the communication terminal is not limited to one. In term of space, it is possible to form as many as four communication terminals.

The rails 22, 23 are formed in shapes that protrude to face each other from the sidewalls of the battery pack mounting part 2c toward a position near the split surface. The rails 22, 23 extend from the open end of the front end to behind the connection terminals 31 to 33, and the concave parts 22a, 23a for engaging with the retaining claws of the latch mechanism are formed in the vicinity of the front end. A terminal unit 30 is fixed between the rails 22, 23 disposed to be parallel. The terminal unit 30 is a unit in which a terminal component made of metal is cast into resin, and is formed by a base part 30a that is solid and in a substantially rectangular parallelepiped shape and an upper wall part 30c extending, in a plate shape, the upper portion of the base part 30a to the front side. The positive electrode terminal 31, the negative electrode terminal 32, and the communication terminal 33 are each a plate-shaped component made of metal and are cast in by penetrating through the base part 30a, and a portion thereof is fixed to protrude toward the front side of the base part 30a. The rear side end part of the plate-shaped component is exposed to the upper side with respect to the base part 30a to form a connection terminal part (not shown), and is connected with a lead wire on the inner side of the housing 2 of the electric apparatus body 1.

The upper side outer edge part of the terminal unit 30 is provided with a groove part (not shown) formed continuously to be recessed toward the inner side along the outer edge, and, in an opening part 24 formed in the housing 2, is fixed to the housing 2 to sandwich the groove part by using the left side part and the right side part. The upper wall part 30c of the terminal unit 30 is a surface facing the upper stage surface 253 of the first adapter or the upper stage surface 104 of the battery pack 100. In addition, a vertical wall part 30b of the terminal unit 30 is a surface facing the stepped part 252 of the first adapter 200 or a stepped part 103 of the battery pack 100. The lower surface of the base part 30a of the terminal unit 30 is a surface facing the lower stage surface 251 of the first adapter or a lower stage surface 102 of the battery pack 100.

In the battery pack installation part 2c, the curved wall 25 curved upward is formed on the front side with respect to the rails 22, 23, and abuts against the raised part 254 (see FIG. 2) of the first adapter 200 or a raised part 105 of the battery pack 100 (see FIG. 9). The concave part 26 is a portion forming a screw hole and a screw boss (neither of which is shown) for screwing the right side piece and the left side piece of the housing 2. The convex part 26 is located in the recess 255 (see FIG. 2) of the first adapter 200 or in a recess 106 of the battery pack 100 (see FIG. 9).

The battery pack 150 is a battery pack normally compatible (directly connectible) with a type of electric apparatus (such as a second electric apparatus body 401 as shown in FIG. 9 to be described afterwards, which is an other-company electric tool) different from the electric apparatus body 1 (such as the own-company electric tool). Here, the battery pack 150 is connected with the electric apparatus body 1 via the first adapter 200. Multiple secondary battery cells, such as lithium ion batteries, are accommodated in the battery pack 150, and a direct current of a rated voltage (e.g., 18V) corresponding to the electric apparatus body 1 is output.

In the first adapter 200, the first installation part 210 allowing the installation of the battery pack 150 is formed on the lower side of the case 201 (201R, 201L) made of synthetic resin. In the first installation part 210, a sidewall surface 221 having a U shape when viewed in a bottom view and extending downward is formed, and, excluding the front side portion in the sidewall surface 221, a rail 222 protruding toward the inner side from the vicinity of the lower end of the right side and a rail 223 protruding toward the inner side from the vicinity of the lower end on the left side are formed. The rails 222, 223 form a rail mechanism of the first installation part of the first adapter 200, and correspond to the groove parts 167, 168 of the battery pack 150 (see FIG. 2).

The upper wall surface 211 of the first installation part 210 is formed at the same height with a horizontal wall 230c of a terminal part 230, and serves as a surface facing the upper stage surface 155 of the battery pack 150. In the vicinity of the center of the upper wall surface 211, a concave part 212 recessed toward the upper side in a mound shape is formed. The concave part 212 is in a shape corresponding to the latch claw 182 (see FIG. 2) of the battery pack 150. When the battery pack 150 is installed to the first installation part 210 of the first adapter 200 and the end parts of the rails 222, 223 are moved to abut against stopper parts 154a, 154b formed at the end parts of the groove parts 167, 168 of the battery pack 150, the latch claw 182 moves upward to fit with the concave part 212, thereby fixing the battery pack 150 to the first adapter 200.

Four connection terminals are cast into the terminal part 230. That is, a positive electrode input terminal 231 and a negative electrode input terminal 232 are disposed to be separated in the left-right direction as power connection terminals. The positive electrode input terminal 231 is inserted into the slot 161 (see FIG. 2) of the battery pack 150, and the negative electrode input terminal 232 is inserted into the slot 162 (see FIG. 2) of the battery pack 150. Between the positive electrode input terminal 231 and the negative electrode input terminal 232, a first communication terminal 233 and a second communication terminal 234 for signal transmission are disposed. The first communication terminal 233 is inserted into the slot 163 (see FIG. 2) of the battery pack 150, and the second communication terminal 234 is inserted into the slot 164 (see FIG. 2) of the battery pack 150.

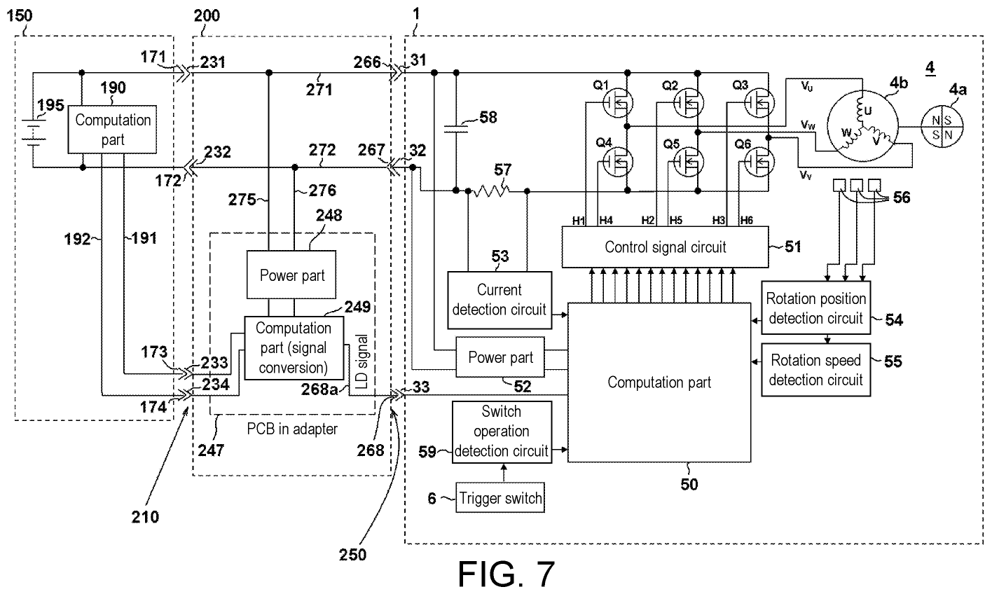

When the battery pack 150 is inserted into the first installation part 210 until the stopper parts 154a, 154b formed on the upper stage surface 155 of the battery pack 150 abut against the abutting portions of the first adapter 200 (until the end parts of the rails 222, 223 abut against the stopper parts 154a, 154b), the connection terminals 231 to 234 provided on the side of the first adapter 200 and the connection terminals 171 to 174 provided on the battery pack 150 (reference is made to FIG. 7 to be described afterwards) contact each other and are conducted. In addition, with the latch claw 182 of the battery pack 150 dashing out upward due to a spring effect to be engaged with the concave part 212 formed in the first adapter 200, the battery pack 150 is prevented from falling off.

FIG. 4 is an exploded perspective view of the first adapter 200 shown in FIG. 1. The case of the first adapter 200 is split in the left-right direction, and is held by sandwiching the terminal part 230 by using the case 201 (201R, 201L). An opening 202R is provided at the lower part of the right side piece 201R of the case 201, and a groove part 203R continuous in the outer edge direction and engaged with the outer edge portion of the right side half of the terminal part 230 is formed on the upper side of the opening part 202R. Although not shown in the drawings, the same opening and groove part are formed in the lower part of the left side piece 201L of the case 201. The right side piece 201R and the left side piece 201L of the case 201 are fixed by two screws not shown herein. Two screw holes 204, 205 are formed in the right side piece 201R, and screw bosses with internal threads are formed at corresponding positions of the left side piece 201L.

In the case 201 assembled by bonding the right side piece 201R and the left side piece 201L, the upper side forms the second installation part 250 connected with the electric apparatus body 1, and the lower side forms the first installation part 210 for connection with the other-company battery pack 150. In the second installation part 250, the groove parts 256 (see FIG. 2), 257 respectively extending in the front-rear direction are formed on the right side surface 213 and the left side surface 214. The front ends of the groove parts 256, 257 are open at the upper side portion of the lower stage surface 251, and in the rear portions, the grooves are blocked by the raised part 254. The latch claws 282 (reference of the symbol is made to FIG. 2), 284 are formed in the vicinity of the rear ends of the groove parts 256, 257. In addition, the latch buttons 281, 283 moving in conjunction with the latch claws 282, 284, respectively, are provided.

On the upper stage surface 253 connecting the upper edges of the right side surface 213 and the left side surface 214, the three slots 261 to 263 are formed. When viewed in a top view, the slots 261 to 263 are in elongated rectangular shapes, and the front end parts are open at the stepped part 252 between the upper stage surface 253 and the lower stage surface 251.

The terminal part 230 forms the input terminal on the side of the first installation part 210 (the lower side in the drawing) and the output terminal on the side of the second installation part 250 (the upper side in the drawing), and transmits signals, or converts and transmits signals, between the signal terminal on the side of the first installation part 210 and the signal terminal of the second installation part 250. The terminal part 230 has a base part 230a as a solid portion made of synthetic resin, and an upper wall part 230b having the same upper surface as the base part 230a is formed to be continuous rearward. The horizontal wall 230c holding a plate-shaped substrate is continuous with the further rear of the upper wall part 230b. The upper wall part 230b and the horizontal wall 230c may be formed as different components and may also be formed integrally.

A circuit substrate 247 is disposed above the horizontal wall 230c. A power part 248 to be described afterwards in FIG. 7 and a computation part 249 including a microcomputer are mounted in the circuit substrate 247. The positive electrode output terminal 266, the negative electrode output terminal 267, and the communication terminal (LD output terminal) 268 are disposed on the upper side of the base part 230a of the terminal part 230. The three terminals are made of metal, and a terminal cover 235 made of synthetic resin is provided on the periohery of the terminals. Meanwhile, four connection terminals 231 to 234 are formed on the lower side of the terminal part 230 (FIG. 4 only illustrates the negative electrode input terminal 232, and the remaining are shown in FIG. 3). The four connection terminals 231 to 234 are formed by metal thin plates, and are cast in the base part 230a manufactured through molding synthetic resin.

The end parts of the connection terminals 231 to 234 are in a shape of being exposed to the upper side of the upper wall part 230b, and the exposed portions serve as connection pieces 236 to 239 for soldering wires. The connection piece 236 is linked with the positive electrode input terminal 231 (reference is made to FIG. 3 to be described afterwards), directly connected with the connection piece of the positive electrode output terminal 266 extending to the rear side by using a thick wire 271 without going through the control unit (the circuit substrate 247 or the computation part 249), and is connected with the circuit substrate 247 via a thin wire 275. The connection piece 237 is linked with the negative electrode input terminal 232, directly connected with the connection piece of the negative electrode output terminal 267 extending to the rear side by using a thick wire 272 without going through the control unit (the circuit substrate 247 or the computation part 249), and is connected with the circuit substrate 247 via a thin wire 276. The connection piece 238 is linked with the first communication terminal 233 and connected to the circuit substrate 247 through a wire 273. The connection piece 239 is linked with the communication terminal 234 and connected to the circuit substrate 247 through a wire 274. The LD output terminal 268 is connected with the circuit substrate 247 via a wire 277.

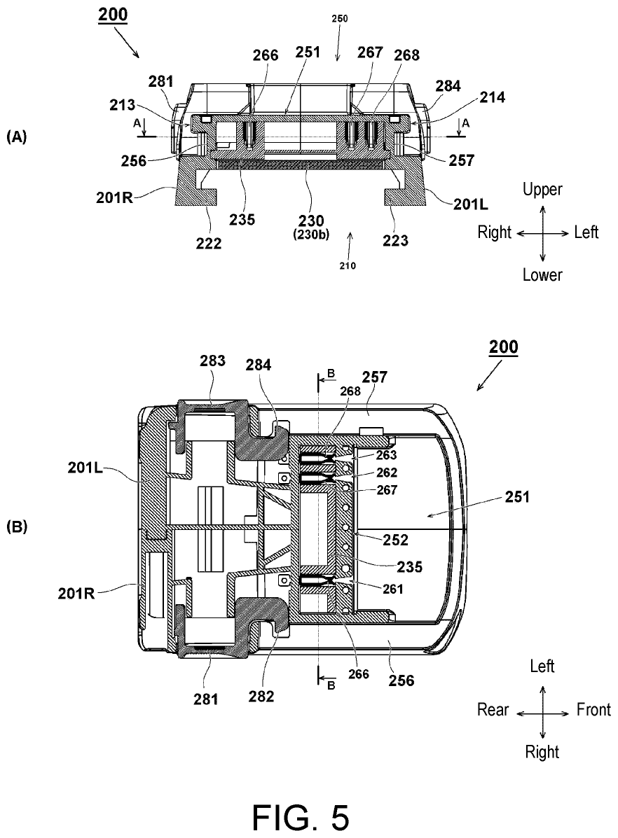

FIG. 5 illustrates a top view and a longitudinal cross-sectional view of the first adapter 200. The cross-sectional position of (A) of FIG. 5 is equivalent to the cross-section of a B-B part in (B) of FIG. 5. In (A) of FIG. 5, the case 201 of the first adapter 200 is formed to be split by using the right side piece 201R and the left side piece 201L, and the terminal part 230 is held to be sandwiched by the right side piece 201R and the left side piece L of the case 201. The second installation part 250 is formed above the upper wall part 230b of the terminal part 230. As the terminal part of the second installation part 250, the positive electrode output terminal 266, the negative electrode output terminal 267, and the LD output terminal 268 are provided. The periphery of the terminal part is covered by the terminal cover 235. On the right side surface 213 and the left side surface 214 of the upper stage surface 253, the groove parts 256, 257 forming the rail mechanism of the second installation part 250 are formed. The latch buttons 281, 283 are provided behind the groove parts 256, 257.

The rails 222, 223 are formed in the first installation part 210. The rail 222 is formed to protrude toward the inner side from the lower end side surface of the right side piece 201R, and the rail 223 is formed to protrude toward the inner side from the lower end side surface of the left side piece 201L.

(B) of FIG. 5 is the cross-sectional view of an A-A part of (A) of FIG. 5. On the rear side of the stepped part 252 of the first installation part 210, the slots 261 to 263 are formed, and, behind the slots 261 to 263, the positive electrode output terminal 266, the negative electrode output terminal 267, and the LD output terminal 268 are disposed. The latch buttons 281, 283 are configured to be pushable from the outer side to the inner side, and the latch claws 282, 284 are linked to the front side of the latch buttons 281, 283.

FIG. 6 is a circuit diagram when the (own-company) battery pack 100 manufactured by the same company as the electric apparatus body 1, for example, and directly connectible with the electric apparatus body 1 is installed to the electric apparatus body 1 of FIG. 1. Although any form can be used as the motor 4 of the electric apparatus body 1, a three-phase brushless DC motor is used in the embodiment. The brushless DC motor has: a rotor 4a formed by including multiple sets (tw sets in the embodiment) of permanent magnets including N and S poles; a stator 4b having star-connected three-phase stator windings U, V, and W; and three rotation position detection elements (Hall elements) 56 disposed at every predetermined interval, such as every 60°, in the circumferential direction for detecting the rotation position of the rotor 4a. Based on the position detection signals from the rotation position detection elements 56, the power conduction directions and times of the stator windings U, V, and W are controlled, and the motor 4 rotates.

The motor 4 is driven by an inverter circuit having six switching elements Q1 to Q6, such as FETs connected in a three-phase bridge configuration. Each gate of the six switching elements Q1 to Q6 that are bridge-connected is connected to a control signal circuit 51, and each drain or each source of the six switching elements Q1 to Q6 are connected with the stator windings U, V, and W that are star-connected. Accordingly, the six switching elements Q1 to Q6 perform switching operation according to the switching element driving signals (driving signals of H4, H5, H6, etc.) input from the control signal circuit 51, and sets the DC voltage of the battery pack 100 applied to the inverter circuit as three-phase (U phase, V phase, and W phase) voltages Vᵤ, Vᵥ, V_{w} and supplies power to the stator windings U, V, and W.

Among the switching element driving signals (three-phase signals) driving the respective gates of the six switching elements Q1 to Q6, the pulse width modulation signals (PWM signals) H4, H5, H6 are supplied to the three negative power side switching elements Q4, Q5, and Q6, and, through a computation part 50, a switch operation detection circuit 59 detects the movement amount (stroke) of the trigger lever 6a operating the trigger switch 6 and outputs the detection signal to the computation part 50. By changing the pulse width (duty ratio) of the PWM signal based on the output of the switch operation detection circuit 59, the computation part 50 adjusts the power supply amount to the motor 4, and controls the starting/stopping and the rotation speed of the motor 4.

While not shown in the drawings, the computation part 50 is formed by including a central processing unit (CPU) for outputting a driving signal based on a processing program and data, a ROM for storing the processing program or control data, a RAM for temporarily storing data, a timer, etc. A reference voltage VCC (e.g., +5V) for operating the computation part 50 is generated by a powe part 52 connected with the positive electrode terminal 31 and the negative electrode terminal 32, and is supplied to the computation part 50 or another electronic circuit.

The computation part 50 forms the driving signal for alternately switching the predetermined switching elements Q1 to Q6 based on the output signal of a rotation position detection circuit 54, and outputs the driving signal to the control signal circuit 51. Accordingly, the predetermined windings of the stator windings U, V, W are alternately conducted with power, and the rotor 4a is rotated in a set rotation direction. The current value supplied to the motor 4 is measured by a current detection circuit 53 by detecting the voltages of two ends of a shunt resistor 57, the rotation speed of the motor 4 is detected by a rotation speed detection circuit 55 by using the output of the rotation position detection circuit 54, and by feeding these values back to the computation part 50, adjustments are made to reach the driving power that is set.

The power part 52 generates the reference voltage (e.g., 5V) at which the computation part 50 operates by using the power from the positive electrode terminal 31 and the negative electrode terminal 32, and a fixed voltage conversion circuit using a three-terminal regulator, for example, is used. A capacitor 58 for smoothing is connected between the positive electrode terminal 31 and the negative electrode terminal 32.

The battery pack 100 is an own-company battery pack, for example, that is directly connectible to the electric apparatus body 1. In the battery pack 100, a battery cell group 145, such as 10 lithium ion battery cells of a rated 3.6V, is accommodated, the battery cells are arranged as two sets, in each of which 5 battery cells are connected in series, and the two sets are connected in parallel, thereby obtaining an output of a rated 18V (in the drawing, the state of parallel connection is not shown). The positive electrode on the side of the battery cell group 145 is connected with the positive electrode terminal 31 via the positive electrode terminal 131, and the negative electrode on the side of the battery cell group 145 is connected with the negative electrode terminal 32 via the negative electrode terminal 137.

A computation part 140 is provided in the battery pack 100. The computation part 140 includes a microcomputer. By using the microcomputer, each voltage of the battery cell is measured, and the charging/discharging with respect to the battery cell is managed. In the case where any battery cell in the battery cell group 145 is in an over-discharged state, the microcomputer of the computation part 140 transmits a discharge inhibit signal (LD signal) via the communication terminal (LD terminal) to stop the use of the entire battery pack 100. The communication terminal 138 is connected with the communication terminal (LD terminal) 33 on the side of the electric apparatus body 1, and the discharge inhibit signal is transmitted to the microcomputer of the computation part 50.

FIG. 7 is a circuit diagram when the other-company battery pack 150, for example, not directly connectible to the electric apparatus body 1 is installed to the electric apparatus body 1 of FIG. 1 via the first adapter 200. The battery pack 150 is an other-company battery, and accommodates a battery cell group 195, such as 10 lithium ion battery cells of a rated 3.6V, the battery cells are arranged as two sets, in each of which 5 battery cells are connected in series, and the two sets are connected in parallel, thereby obtaining an output of a rated 18V (in the drawing, the state of parallel connection is not shown). The positive electrode on the side of the battery cell group 195 is connected with the positive electrode input terminal 231 of the first adapter 200 via the positive electrode terminal 171, and the negative electrode on the side of the battery cell group 195 is connected with the negative electrode input terminal 232 via the negative electrode terminal 172.

A computation part 190 is provided in the battery pack 150. The computation part 190 includes a microcomputer. By using the microcomputer, each voltage of the battery cell is measured, and the charging/discharging with respect to the battery cell is managed. The microcomputer of the computation part 190 outputs a temperature signal of the battery cell group 195 to the first signal terminal 173. In addition, in the case where the microcomputer of the computation part 190 detects the overload state of any of the battery cell group 195, an overload signal 192 is output to the second signal terminal 174.

In the first adapter 200, the positive electrode input terminal 231, the negative electrode input terminal 232, and the communication terminals 233, 234 are formed on the side of the first installation part 210. In addition, on the side of the second installation part 250 of the first adapter 200, the positive electrode output terminal 266, the negative electrode output terminal 267, and one signal terminal (communication terminal) that is, the LD output terminal 268, are formed. The positive electrode input terminal 231 and the positive electrode output terminal 266 are directly connected by the thick wire 271. Likewise, the negative electrode input terminal 232 and the negative electrode output terminal 267 are directly connected by the thick wire 272.

The power part 248 and the computation part 249 are mounted on the circuit substrate 247 of the first adapter 200. Power is supplied from the positive electrode input terminal 231 and the negative electrode input terminal 232 to the power part 248 via the wires 275, 276, and the power part 248 supplies the reference voltage VCC for operation of the computation part 249. The power part 248, for example, is a fixed voltage conversion circuit using a three-terminal regulator. The computation part 249 includes a microcomputer, and, by using the microcomputer, the signals input from the first communication terminal 233 and the second communication terminal 234 are converted to conform to the communication standard on the side of the electric apparatus body 1. Here, a communication signal (LD signal) 268a is generated from the two signals input from the first communication terminal 233 and the second communication terminal 234, and is output to the communication terminal (LD output terminal) 268. The computation part 249 is equivalent to an adapter control unit. It is noted that the adapter control unit may also be configured by including a logic computation circuit or a computation circuit using a microcomputer.

Such first adapter 200 converts the terminals (171, 172) of the battery pack 150 of an other company or having a different manufacturing company that is not directly connectible with the electric apparatus body 1 into the connection terminals (266, 267) fitting the shapes of the terminals (31, 32) of the electric apparatus body 1. In addition, the computation part 249 of the first adapter 200 converts the signals (the temperature signal and the overload signal in the example) output from the other-company battery pack 150 into the communication signal (LD signal) receivable by the side of the electric apparatus body 1. In this way, in addition to power transmission, the first adapter 200 converts the communication signal from the battery pack 150 that is not directly connectible with the electric apparatus body 1 into the communication signal compatible with the electric apparatus body 1 that is the transmission destination. Therefore, it is possible to use the other-company battery pack 150 that is not directly connectible with the electric apparatus body 1 as the power source of the electric apparatus body 1.

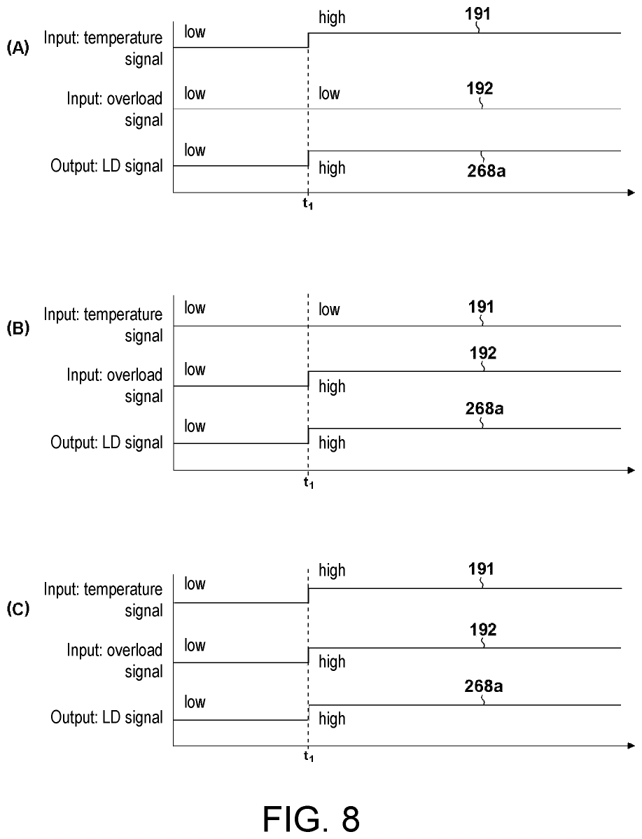

In the following, the relationship between the input signal (Input) and the output signal (Output) in the computation part 249 of the first adapter 200 is described by using FIG. 8. The vertical axis indicates the level (high or low) of each signal, and the vertical axis indicates the passing of time. Here, as the input from the battery pack 150 to the first adapter 200, the temperature signal 191 and the overload signal 192 from the battery pack 150 are transmitted, and as the output from the first adapter 200 to the LD terminal 33 of the electric apparatus body 1, the LD signal 268a is transmitted to the LD output terminal 268.

The temperature signal 191 of the battery pack 150 shown in FIG. 7 is at the Low level if it is within a tolerance range (e.g., less than +50° C.), and once the temperature exceeds the tolerance range, the voltage of the high level is output to the signal terminal 173. In addition, the overload signal 192 of the battery pack 150 is at the Low level if the battery voltage is within the tolerance range or more (e.g., 12V or more), and once the battery voltage drops below 12V, the voltage of the high level is output to the signal terminal 174. In addition, as the overload signal 192, if the current flowing through the battery pack 150 is less than a predetermined value, the overload signal 192 is at the Low level, and if the current is equal to or more than the predetermined value, the overload signal 192 is switched to the high level.

The communication signal (LD signal) 268a in the battery pack 100 is at the high level if the side of the battery pack 100 is in the over-discharged state, that is, if any of the battery cells drops to or below a usage lower limit voltage. The computation part 249 (see FIG. 7) of the first adapter 200 receives the temperature signal 191 and the overload signal 192 output from the battery pack 150, and replaces the signals with the LD signal of the battery pack 100 to be output to the communication terminal 33 (LD terminal) of the electric apparatus body 1.

(A) of FIG. 8 illustrates the state that the temperature signal 191 and the overload signal 192 are both in the Low state until a time t₁. In such state, the computation part 249 (see FIG. 7) of the first adapter 200 maintains the LD signal 268a in the Low state. At the time t₁, the temperature of the battery rises to exceed the tolerance range, and the temperature signal 191 becomes high, and the overload signal 192 is maintained at Low even after the time t₁. Thus, at the time t₁, the computation part 249 (see FIG. 7) of the first adapter 200 switches the LD signal 268a to high, and outputs the LD signal 268a from the LD output terminal 268 (see FIG. 7). Through transmission of the LD signal 268a, the operation of the electric apparatus body 1 is blocked.

In (B) of FIG. 8, the following state is shown: until the time t₁, the temperature signal 191 and the overload signal 192 are both Low, and at the time t₁, the battery voltage is below the tolerance range and the overload signal 192 becomes high. The temperature signal 191 remains Low even after the time t₁. In such case, at the time t₁, the computation part 249 (see FIG. 7) of the first adapter 200 switches the LD signal 268a to high, and outputs the LD signal 268a from the LD output terminal 268 (see FIG. 7).

In (C) of FIG. 8, the following state is shown: until the time t₁, the temperature signal 191 and the overload signal 192 are both Low, and at the time t₁, the temperature signal 191 and the overload signal 192 both become high. In such case, at the time t₁, the computation part 249 (see FIG. 7) of the first adapter 200 switches the LD signal 268a to high, and outputs the LD signal 268a from the LD output terminal 268 (see FIG. 7).

In the waveforms shown in FIG. 8, for the simplicity of description, a simple OR output is shown. That is, it is described that the LD signal 268a conforms to the OR computation results of the temperature signal 191 and the overload signal 192. However, any of the following configuration would suffice: a configuration in which, based on the difference in the interface of the signal terminal between the battery pack 150 and the electric apparatus body 1, the computation part 249 (see FIG. 7) of the first adapter 200 becomes a simple logic computation result, or a configuration in which, after a sophisticated conversion process using computer software, the LD signal 268a is determined and output from the LD output terminal 268a. Since a microcomputer is mounted to the computation part 249 of the first adapter 200 in the embodiment, the conversion process of the communication signal can be arbitrarily carried out. In addition, it may also be configured that the microcomputer of the computation part 249 does not use all of the multiple signals output from the battery pack 150, but selects a signal used for determining the LD signal 268a and does not use the remaining signals. In addition, in the case where the input signals (the temperature signal 191, the overload signal 192) to the computation part 249 and the output signal (the LD signal 268a) are at the same levels at the time of being normal and the time of being abnormal, for example, in the case of being at the Low level at the time of being normal and being changed to the high level at the time of being abnormal, it may also be that one of the input signals is directly output as the output signal.

FIG. 9 is an expanded perspective view when the own-company battery pack 100 is installed to the other-company electric apparatus body 401 (an electric apparatus body to which the battery pack 100 is not directly connectible) by using the second adapter 300. The other-company electric apparatus body 401, for example, is an impact driver, and operates at the same voltage as that of the own-company electric apparatus body 1 (the electric apparatus to which the battery pack 100 is directly connectible). A housing 402 of the electric apparatus body 401 has a body part 402a and a grip part 402b extending downward from the body part 402a. A battery pack installation part 420 (body side installation part) is formed below the grip part 402b. The shape of the battery pack installation part 420 is the same as the shape of the first installation part 210 shown in FIG. 3.

The battery pack 100 is compatible (directly connectible) with the own-company electric apparatus body 1 shown in FIG. 1, and multiple battery cells are accommodated in the case 101 made of synthetic resin. A rail mechanism, that is, two rail grooves 125, 126 (not shown in FIG. 9), for installation to the electric apparatus body 1 is provided at the upper part of the battery pack 100. The lower stage surface 102 and the upper stage surface 104 of the case 101 are formed in a stepped shape to have different heights, and a slot group 120 of eight slots extending from the stepped portions thereof toward the rear side is formed. Inside the notch portions, multiple connection terminals (connection terminal group) are arranged. Among the eight slots, the positive electrode terminal is provided at a slot 122, which is the second one from the right, the negative electrode terminal is provided at a slot 127, which is the seventh slot, and the LD terminal is provided at a slot 128, which is the eighth slot. Behind the connection terminal group, a latch mechanism (latch part) for maintaining or removing the installation state with the electric apparatus body 1 is provided. The latch mechanism on the right side is formed by including a latch button 116 and a latch claw 117 moving in conjunction with the latch button 116. While not shown in the drawing, a latch button and a latch claw are also disposed on the right side surface of the battery pack 100.

In the second adapter 300, a first installation part 310 compatible with the battery pack 100 is formed on the lower side, and a second installation part 350 compatible with the electric apparatus body 401 is formed on the upper side. The shape of the first installation part 310 is compatible with the shape of the battery pack installation part 2c shown in FIGS. 2 and 3. In addition, the shape of the second installation part 350 is compatible with the installation part 160 of the battery pack 150 shown in FIGS. 2 and 3. The basic configuration of the second adapter 300 is the same as the first adapter 200 shown in FIG. 4. A rail mechanism and a latch mechanism are formed by a case 301 (301R, 301L) split in the left-right direction, with a terminal part (not shown) being interposed. The shape of the terminal part is set in accordance with the shapes of the first installation part 310 and the second installation part 350 or the arrangement of the connection terminals. FIG. 10 illustration a portion (in the vicinity of the communication terminal) of the circuit diagram when the first battery pack 100, the second adapter 300, and the electric apparatus body 401 are connected. The rest of the configuration is the same as FIGS. 6 and 7 and therefore omitted. As shown in FIGS. 9 and 10, in the first installation part 310, a positive electrode input terminal connected with the positive electrode terminal 131 of the battery pack 100, a negative electrode input terminal connected with the negative electrode terminal 137 of the battery pack 100, and a communication terminal (LD terminal) 301 connected with the communication terminal (LD terminal) of the battery pack 100 are provided. In the second installation part 350, slots 361 to 364 in which connection terminals are accommodated are formed. In the second adapter 300 as well, a computation part 304 including a microcomputer is provided, and through the computation part 304, bridging of communication signals between the battery pack 100 (the computation part 140) and the electric apparatus body 401 (a computation part 413) is performed.

In the slot 361, a positive electrode output terminal connected with the positive electrode input terminal is accommodated. In the slot 364, a negative electrode output terminal connected with the negative electrode input terminal is accommodated. In the slot 362, a first signal terminal (communication terminal) 302 connected with a first signal terminal 410 into which the first signal (temperature signal) of the electric apparatus body 401 is input is accommodated. In the slot 363, a second signal terminal (communication terminal) 303 connected with a second signal terminal 411 into which the second signal (overload signal) of the electric apparatus body 401 is input is accommodated.

The signal 110 input from the battery pack 100 (the computation part 140) is input to the second adapter 300 (the computation part 304) via the communication terminals 138 and 301. When an abnormal signal (discharge inhibit signal, LD signal) indicating an abnormal state is input, as the signal 110, to the computation part 340, at least one of the first signal (temperature signal) 370 and the second signal (overload signal) 380 is switched from the normal state to the abnormal state and output to the electric apparatus body 401 (the computation part 412) via each communication terminal.

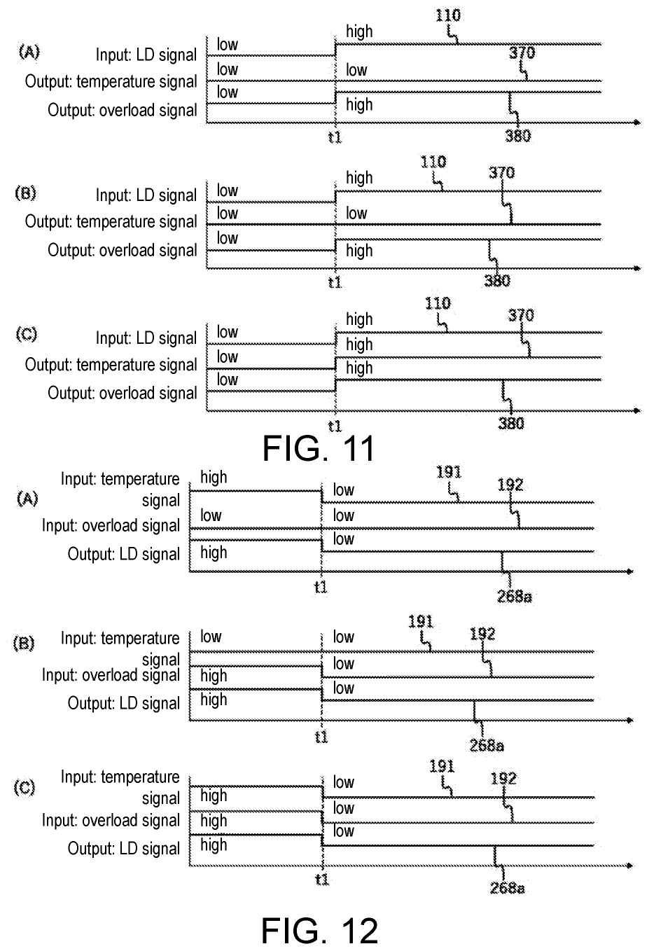

FIG. 11 is a waveform of the input signal 110 and the output signals 370, 380 of the adapter control unit 412 in the second adapter 300 of FIG. 9. The vertical axis indicates the level (high or low) of each signal, and the vertical axis indicates the passing of time. As an input from the battery pack 100 to the second adapter 300, the abnormal signal 110 from the battery pack 100 is transmitted. As an output from the second adapter 300 to the first signal terminal 410 of the electric apparatus body 401, the first signal (temperature signal) 370 is output to the first signal terminal 302. As an output from the second adapter 300 to the second signal terminal 411 of the electric apparatus body 401, the second signal (the overload signal 380) is output to the second signal terminal 303.

If the computation part 140 of the battery pack 100 determines any of the case where the battery pack 100 or any battery cell drops to or below a non-usage lower voltage limit, the case where the current flowing through the battery pack 100 increases to or above an overcurrent threshold, and the case where the temperature of the battery pack 100 exceeds a pack tolerance range, the signal output from the computation part 140 of the battery pack 100 is switched from the Low level indicating the normal state to the abnormal signal 110 of the high level indicating the abnormal state.

When the abnormal signal 110 is input, the computation part 304 of the second adapter 300 switches at least one of the first signal 370 and the second signal 380 from the Low level indicating the normal state to the high level indicating the abnormal state.

In (A) of FIG. 11, until the time t₁, the signal 110 is in the state of Low. Therefore, the first and second signals 370, 380 are also in the state of Low. That is, the computation part 304 of the second adapter 300 maintains the first and second signals 370, 380 in the state of Low. At the time t₁, when a signal 1110 of the battery pack 100 becomes high indicating the abnormal state, the computation part 304 of the second adapter 300 maintains the state that the first signal 370 is low, while switching the second signal 380 to high, and outputs from the second signal terminal 303. By transmitting the second signal 380 indicating the abnormal state, the operation of the electric apparatus body 401 is blocked (stopped or prohibited).

(B) of FIG. 11 is the same as (A) of FIG. 11 until the time t₁. At the time t₁, when the signal 1110 of the battery pack 100 becomes high indicating the abnormal state, the computation part 304 of the second adapter 300 maintains the state that the second signal 380 is low, while switching the first signal 370 to high, and outputs from the first signal terminal 302. By transmitting the first signal 370 indicating the abnormal state, the operation of the electric apparatus body 401 is blocked (stopped or prohibited).

(C) of FIG. 11 is the same as (A) of FIG. 11 until the time t₁. At the time t₁, when the signal 1110 of the battery pack 100 becomes high indicating the abnormal state, the computation part 304 of the second adapter 300 switches the first and second signals 370, 380 to high, and outputs from the first and second signal terminals 301, 302, respectively. By transmitting the first signal 370 indicating the abnormal state, the operation of the electric apparatus body 401 is blocked (stopped or prohibited).

In the case where at least one of the signals input via the first and second signal terminals 410, 411 indicates the abnormal state (high), the computation part 412 of the electric apparatus body 401 determines that an abnormality occurs in the battery pack 100. Accordingly, the operation of the electric apparatus body 401 can be blocked.

Although the invention has been described above based on the embodiments, the invention is not limited to the above-described embodiments, and various modifications can be made without departing from the scope of the invention. For example, in the above embodiments, the examples of the first adapter 200 and the second adapter 300 are described as the adapter. However, a configuration in which a third adapter for installing a battery pack (second battery pack) of yet another shape or another company (manufacturing company) to the electric apparatus body 1 (first electric apparatus body) or a fourth adapter for installing the own-company battery pack 100 (first battery pack) to the electric apparatus body (second electric apparatus body) of yet another shape or company (manufacturing company) is prepared also falls within the scope of the invention. In addition, in the above embodiments, the battery pack and the electric apparatus body of the own company and another manufacturing company (another company) different from the own company are described. However, the invention is not limited to the own company and the another company. The battery pack and the electric apparatus body may be made by the same company (manufacturing company). For example, the case where the battery pack and the electric apparatus body are not directly connectible because of a difference in rated voltage between the battery pack and the electric apparatus body is also applicable. In addition, the signal indicating an abnormality may be reversed in terms of high and low. In FIGS. 8 and 11, it is described that the state is low at the time of being normal, and the state is high at the time of being abnormal. However, as shown in FIG. 12 that is a modified example of FIG. 8, it may also be that the state is high at the time of being normal and the state is low at the time of being abnormal. In such case, the computation part 249 of the first adapter 200 may be programmed in advance to determine that the state is normal if the input signals from the terminals 233, 234 are high, and the state is abnormal if the input signals from the terminals 233, 234 are low. In addition, with respect to the signals of FIG. 8, it may also be that only one of the input signal and the output signal of the computation part 249 is reversed, and the input signal is normal if it is low and the output signal is abnormal if it is low. Moreover, in addition to a configuration that drives by using the power of the battery pack, a charging device that charges the battery pack may also serve as the electric apparatus body.

### REFERENCE SIGNS LIST

1: Electric apparatus body; 2: Housing; 2a: Body part; 2b: Grip part; 2c: Battery pack installation part; 4: Motor; 4a: Rotor; 4b: Stator; 6: Trigger switch; 6a: Trigger lever; 9: Chuck mechanism; 15: Operation panel; 22, 23: Rail; 22a, 23a: Concave part; 24: Opening part; 25: Curved wall; 26: Convex part; 27: Illumination device; 28: Hook; 29: Screw; 30: Terminal unit; 30a: Base part; 30b: Vertical wall part; 30c: Upper wall part; 31: Positive electrode terminal; 32: Negative electrode terminal; 33: Communication terminal (LD terminal); 50: Computation part; 51: Control signal circuit; 52: Power part; 53: Current detection circuit; 54: Rotation position detection circuit; 55: Rotation speed detection circuit; 56: Rotation position detection element; 57: Shunt resistor; 58: Capacitor; 59: Switch operation detection circuit; 100: (First) battery pack; 101: Case; 102: Lower stage surface; 103: Stepped part; 104: Upper stage surface; 105: Raised part; 106: Recess; 116: Latch button; 117: Latch claw; 120: Slot group; 122,127,128: Slot; 125,126: Rail groove; 131: Positive electrode terminal; 137: Negative electrode terminal; 138: Communication terminal (LD terminal); 140: Computation part; 145: Battery cell group; 150: (Second) battery pack; 153: Lower stage surface; 154a, 154b: Stopper part; 155: Upper stage surface; 160: Installation part; 161 to 164: Slot; 167, 168: Groove part; 171: Positive electrode terminal; 172: Negative electrode terminal; 173: First signal terminal; 174: Second signal terminal; 181: Latch button; 182: Latch claw; 190: Computation part; 191: Temperature signal; 192: Overload signal; 195: Battery cell group; 200: First adapter; 201: Case; 201R: Right side piece; 201L: Left side piece; 202R: Opening; 203R: Groove part; 204,205: Screw hole; 210: First installation part; 211: Upper wall surface; 212: Concave part; 213: Right side surface; 214: Left side surface; 221: Sidewall surface; 222, 223: Rail; 230: Terminal part; 230a: Base part; 230b: Upper wall part; 230c: Horizontal wall; 231: Positive electrode input terminal; 232: Negative electrode input terminal; 233: First communication terminal; 234: Second communication terminal; 235: Terminal cover; 236 to 239: Connection piece; 247: Circuit substrate; 248: Power part; 249: Computation part; 250: Second installation part; 251: Lower stage surface; 252: Stepped part; 253: Upper stage surface; 254: Raised part; 255: Recess; 256, 257: Groove part; 261 to 263: Slot; 266: Positive electrode output terminal; 267: Negative electrode output terminal; 268: LD output terminal; 268a: LD signal; 271 to 275: Wire; 275, 276: Groove part; 281,283: Latch button; 282,284: Latch claw; 300: Second adapter; 301: Case; 310: First installation part; 350: Second installation part; 353: Upper stage surface; 367: Rail; 401: Electric apparatus body; 402: Housing; 402a: Body part; 402b: Grip part; 420: Battery pack installation part.

1. An adapter, connected between a battery pack and an electric apparatus body, the adapter comprising:
a first installation part, which has a first communication terminal connectible with a communication terminal of the battery pack and to which the battery pack is installable;
a second installation part, which has a second communication terminal connectible with a communication terminal of the electric apparatus body and is installable to the electric apparatus body; and
an adapter control unit, connected with the first communication terminal and the second communication terminal and, configured to, based on an input signal input from one of the first communication terminal and the second communication terminal, output an output signal to an other of the first communication terminal and the second communication terminal.

2. The adapter as claimed in claim 1, wherein the first installation part and the second installation part have different shapes, and the adapter is configured to be able to install the battery pack corresponding to the first installation part to the electric apparatus body corresponding to the second installation part.

3. The adapter as claimed in claim 2, wherein the first installation part and a body side installation part of the electric apparatus body have different shapes, and the battery pack is directly installable to the first installation part and not directly installable to the body side installation part.

4. The adapter as claimed in claim 1, wherein a pair of first rail mechanisms substantially extending in parallel are formed at the first installation part, and a pair of second rail mechanisms substantially extending in parallel are formed at the second installation part, and
the first rail mechanisms and the second rail mechanisms respectively have different shapes.

5. The adapter as claimed in claim 4, wherein the adapter is formed in a split form with a first housing and a second housing,
a side of the first rail mechanisms is provided at a side of the first housing, and an other side is provided at the second housing,
a side of the second rail mechanisms is provided at the side of the first housing, and an other side is provided at the second housing, and
the first and second housings are split in a direction intersecting with extension directions of the first rail mechanisms and the second rail mechanisms.

6. The adapter as claimed in claim 1, wherein the adapter control unit is configured to, in accordance with the input signal input from one of the battery pack and the electric apparatus body, output the output signal different from the input signal or the output signal corresponding to the input signal to an other of the battery pack and the electric apparatus body.

7. The adapter as claimed in claim 1, comprising:
a battery side power terminal, connected with a power terminal of the battery pack that is connected; and
an apparatus side power terminal, connected with a power terminal of the electric apparatus body,
wherein the battery side power terminal and the apparatus side power terminal are directly connected or connected without via the adapter control unit.

8. The adapter as claimed in claim 7, wherein the adapter control unit is provided at a substrate, and
the first and second communication terminals are connected with the adapter control unit via the substrate, and the battery side power terminal and the apparatus side power terminal are connected with each other without via the substrate.

9. The adapter as claimed in claim 7, wherein the adapter control unit is formed by using a logic computation circuit or a computation circuit using a microcomputer, and
the adapter is provided with a power circuit supplying an operation voltage to the computation circuit from power supplied from the battery side power terminal.

10. An electric apparatus, comprising:
the adapter as claimed in claim 1;
a battery pack; and
an electric apparatus body, having a load part and a battery pack installation part,
wherein the adapter is connectible with the electric apparatus body.

11. An electric apparatus, comprising:
the adapter as claimed in claim 1; and
a battery pack, having at least one battery cell,
wherein the adapter is connectible with the battery pack.

12. An electric apparatus, comprising:
the adapter as claimed in claim 1; and
an electric apparatus body, having a load part and a batter pack installation part,
wherein the adapter is connectible with the electric apparatus body.

13. An electric apparatus body connectible with the adapter as claimed in claim 1, comprising:
a load part;
a battery pack installation part, directly installable with one of the adapter and a battery pack; and
a body side communication terminal, connectible with one of the second communication terminal of the adapter and configured to input an input signal from the second communication terminal or output an output signal to the second communication terminal.

14. An electric apparatus body connectible with an adapter having a first communication terminal, a second communication terminal and an adapter control unit configured to, based on an input signal input from one of the first communication terminal and the second communication terminal, output an output signal to an other of the first communication terminal and the second communication terminal, the electric apparatus body comprising:
a load part;
a battery pack installation part, directly installable with one of the adapter and a battery pack; and
a body side communication terminal, connectible with the second communication terminal of the adapter and configured to input an input signal from the second communication terminal or output an output signal to the second communication terminal.
